(19) United States
(12) Patent Application Publication
(10) Pub. No.: US 2024/0394299 A1
(43) Pub. Date: Nov. 28, 2024

(54) TRANSLATION CORRECTION WHEN PERFORMING GUI GLOBALIZATION TESTING

(71) Applicant: International Business Machines Corporation, Armonk, NY (US)

(72) Inventors: Dong Chen, Beijing (CN); Ming Lei Zhang, Beijing (CN); Yuan Jie Zhang, Ningbo (CN); Yin Xi Guo, Beijing (CN); Ting Ting Zhan, Beijing (CN)

(73) Assignee: International Business Machines Corporation, Armonk, NY (US)

(21) Appl. No.: 18/202,907

(22) Filed: May 27, 2023

(51) Int. Cl. G06F 16/583; G06F 3/04842

(52) U.S. Cl. CPC G06F 16/5846; G06F 3/04842

(57) ABSTRACT

A method for correcting translation errors when performing GUI globalization testing is disclosed. In one embodiment, such a method takes a screenshot of a graphical user interface (GUI). The method further enables a user to select text in the screenshot. In certain embodiments, one or more of the text and coordinates associated with the text are stored in picture attributes associated with the screenshot. In response to the selection, the method automatically retrieves a file in which at least some portion of the text is contained. The method automatically locates, within the file, the portion, and enables the user to update the portion in the file in order to update corresponding text in the graphical user interface. In certain embodiments, the method provides a probability percentage associated with the file that indicates a probability that the text in the file links to the selected text in the graphical user interface.

### BACKGROUND

### Field of the Invention

This invention relates generally to software globalization testing, and more particularly to techniques for correcting translation errors when performing software globalization testing.

### Background of the Invention

Globalization testing for graphical user interfaces (GUIs) is an essential aspect of software development in today's globalized world. As companies expand their operations across the globe, it becomes increasingly important to ensure that software applications can be used by people from different regions, cultures, and languages. This may enable companies to tap into new markets, increase their customer base, and gain a competitive advantage. Moreover, globalization testing helps to ensure that the user experience of an application is consistent and user-friendly across different languages and cultures.

Among other tasks, globalization testing involves testing an application's ability to display and support different languages, including non-Latin character sets, such as Cyrillic, Arabic, or Chinese. When a textual error is identified in an application's user interface for a particular language, correcting the error may be a time-consuming and laborious process. For example, correcting such an error may involve identifying and locating a file in which the text is contained, finding the text in the file, correcting the text, and saving the file. The user interface may then need to be viewed or rendered again to ensure that the error was successfully corrected and displays in the desired manner.

### SUMMARY

The invention has been developed in response to the present state of the art and, in particular, in response to the problems and needs in the art that have not yet been fully solved by currently available systems and methods. Accordingly, systems and methods have been developed to correct translations when performing GUI globalization testing. The features and advantages of the invention will become more fully apparent from the following description and appended claims, or may be learned by practice of the invention as set forth hereinafter.

Consistent with the foregoing, a method for correcting translation errors when performing GUI globalization testing is disclosed. In one embodiment, such a method takes a screenshot of a graphical user interface (GUI). The method further enables a user to select text in the screenshot. In certain embodiments, one or more of the text and coordinates associated with the text are stored in picture attributes associated with the screenshot. In response to the selection, the method automatically retrieves a file in which at least some portion of the text is contained. The method automatically locates, within the file, the portion, and enables the user to update the portion in the file in order to update corresponding text in the graphical user interface. In certain embodiments, the method provides a probability percentage associated with the file that indicates a probability that the text in the file links to the selected text in the graphical user interface.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one example of a graphical user interface configured to support different languages;

FIG. 3 is a high-level block diagram showing selection of text in the graphical user interface;

FIG. 4 is a high-level block diagram showing coordinates for the selected text in the graphical user interface;

FIG. 5 is a high-level block diagram showing capture of a screenshot of the graphical user interface;

FIG. 6 is a high-level block diagram showing a translation correction module and various internal sub-modules for correcting translation errors when performing GUI globalization testing;

FIG. 7 is a process flow diagram showing one embodiment of a method for correcting translation errors when performing GUI globalization testing;

FIG. 8 is a process flow diagram showing one embodiment of a method for determining probability percentages for files containing selected text; and

FIG. 9 is a process flow diagram showing an example of determining probability percentages for files containing selected text, including the text with reduced granularity.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “translation correction module 150”) for correcting translation errors when performing GUI globalization testing. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

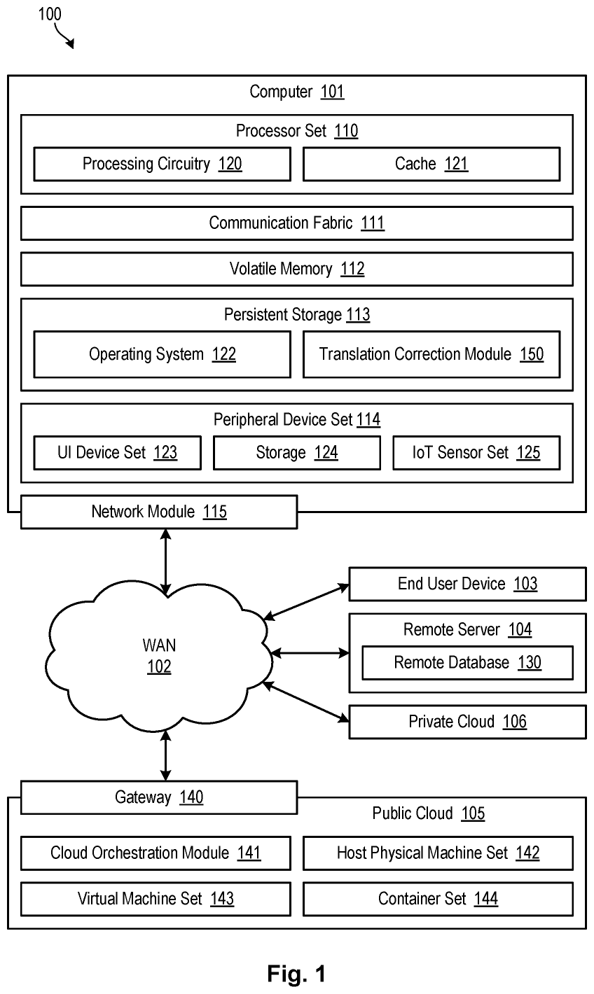

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

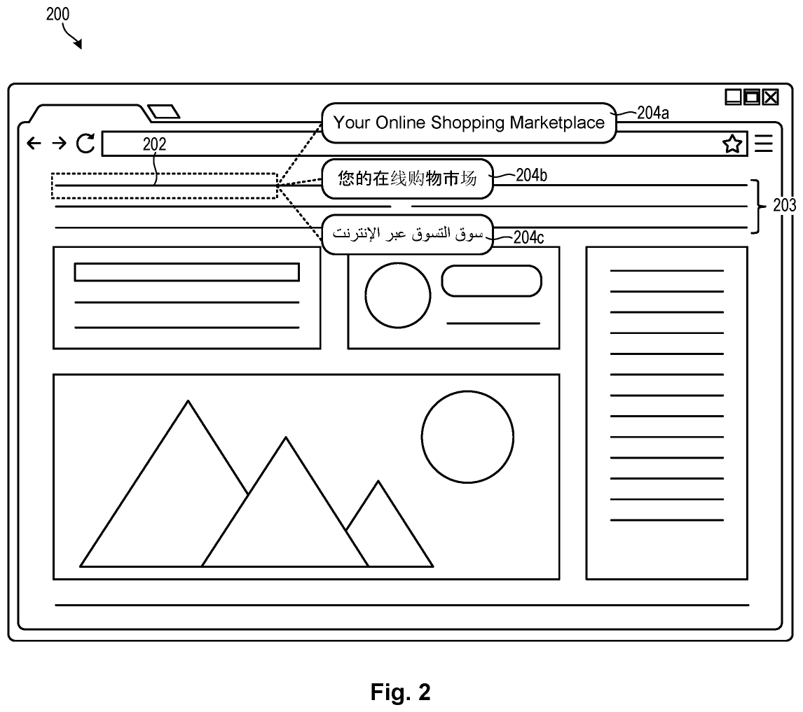

Referring to FIG. 2, as previously mentioned, globalization testing for graphical user interfaces (GUIs) is an essential aspect of software development in today's globalized world. Among other tasks, globalization testing may involve testing an application's ability to display and support different languages, including non-Latin character sets, such as Cyrillic, Arabic, or Chinese. When a textual error is identified in an application's user interface for a particular language, correcting the error has traditionally been a time-consuming and laborious process. For example, correcting such an error may involve identifying and locating a file in which the text is contained, finding the text in the file, correcting the text, and saving the file. The user interface may then need to be viewed or rendered again to ensure that the error was successfully corrected and displays in the desired manner.

FIG. 2 is a high-level block diagram showing one example of a graphical user interface 200 configured to support various different languages. As shown, the graphical user interface 200 may include various lines 203 of text. These lines 203 of text may be presented in different languages, including non-Latin character sets such as Cyrillic, Arabic, or Chinese. For example, a line 202 of text may be presented in one of several different languages 204a-c depending on the region, country, or culture to which the graphical user interface 200 is targeted. Globalization testing may be performed on the graphical user interface 200 to ensure that the user experience of the application is consistent and user-friendly across regions, countries, or cultures and to ensure that the languages 204a-c are presented correctly.

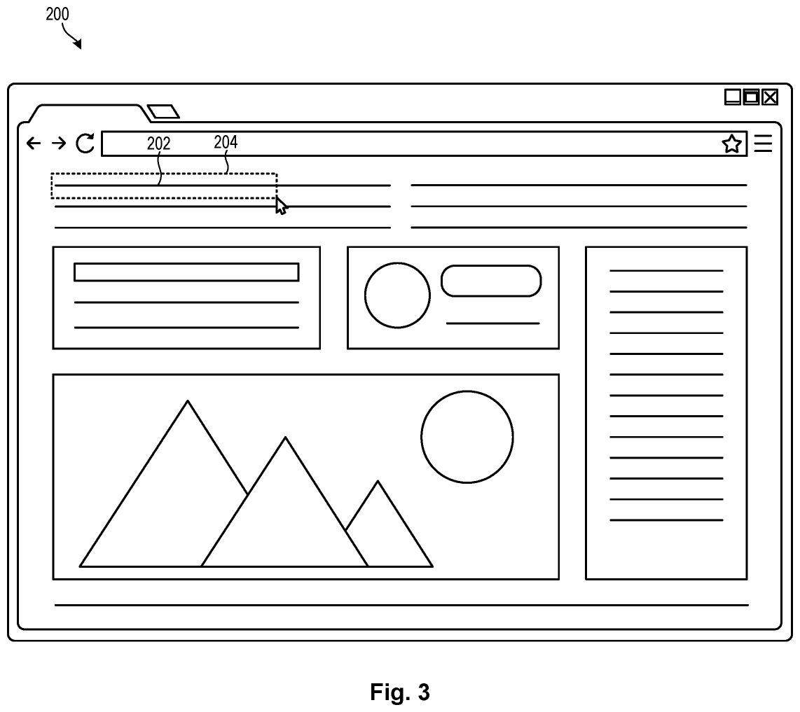

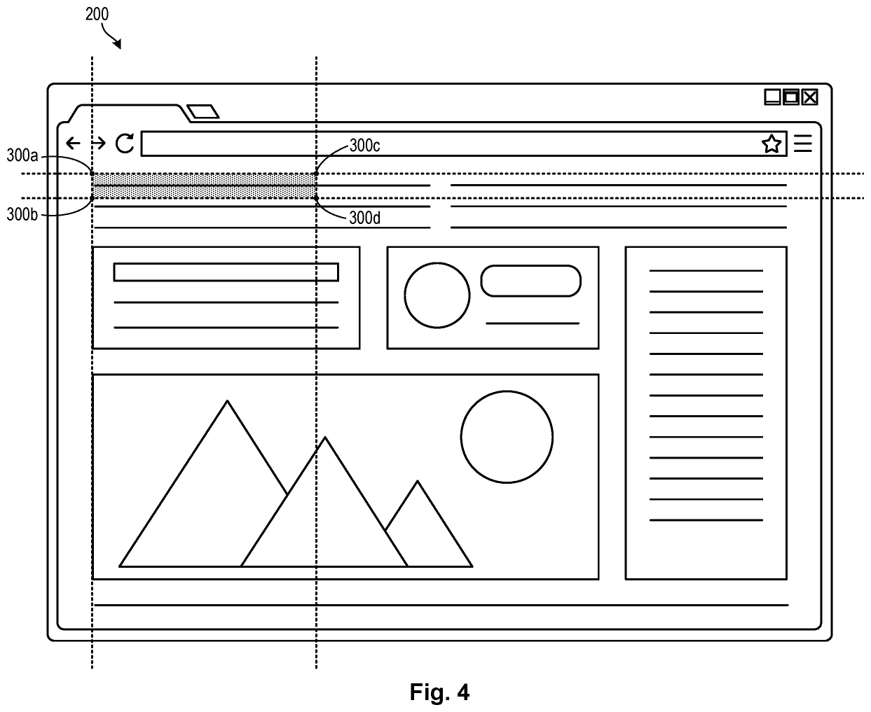

Referring to FIG. 3, in certain embodiments in accordance with the invention, text 202 of interest may be selected on the graphical user interface 200 that may require a translation or other correction. In certain embodiments, this selection 204 may be defined by coordinates 300a-d, as shown in FIG. 4. These coordinates may define a selection area 204 on the graphical user interface 200.

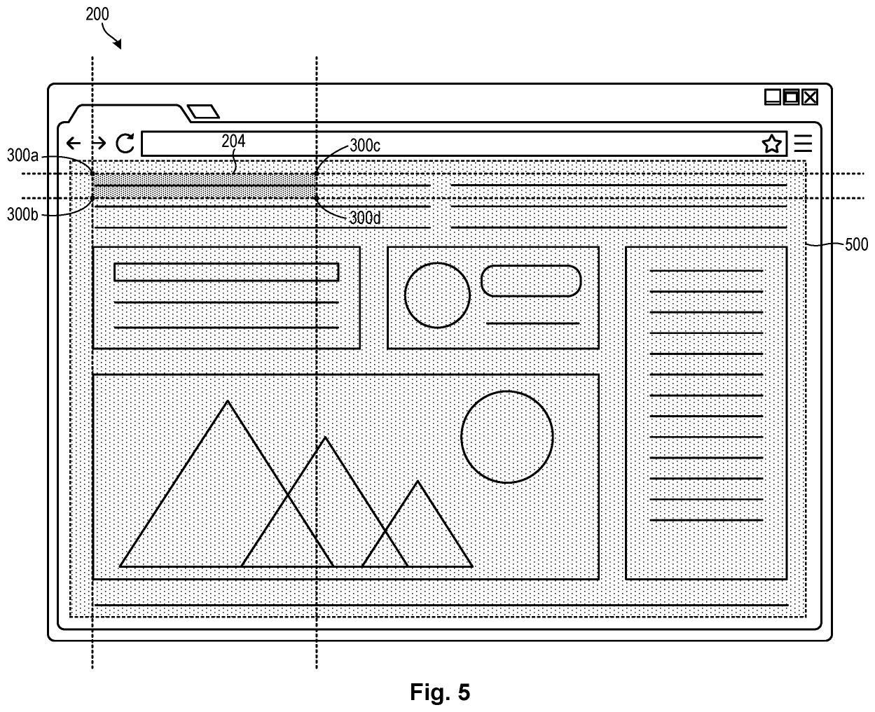

Referring to FIG. 5, when performing a globalization testing, one common technique is to take a screenshot of the graphical user interface 200 and then to analyze text on the screenshot to determine if any corrections are needed to the translations. For example, FIG. 5 shows one example of a screenshot 500 that may be taken of all or part of a graphical user interface 200. When this screenshot is captured, the coordinates 300a-d of the selection area 204 that were defined with respect to the graphical user interface 200 may change relative to the screenshot 500. Thus, in certain embodiments, new coordinates 300a-d may be calculated for selected text 202 within the screenshot 500. In certain embodiments, the selected text 202 as well as its coordinates 300a-d may be saved in picture attributes associated with the screenshot 500.

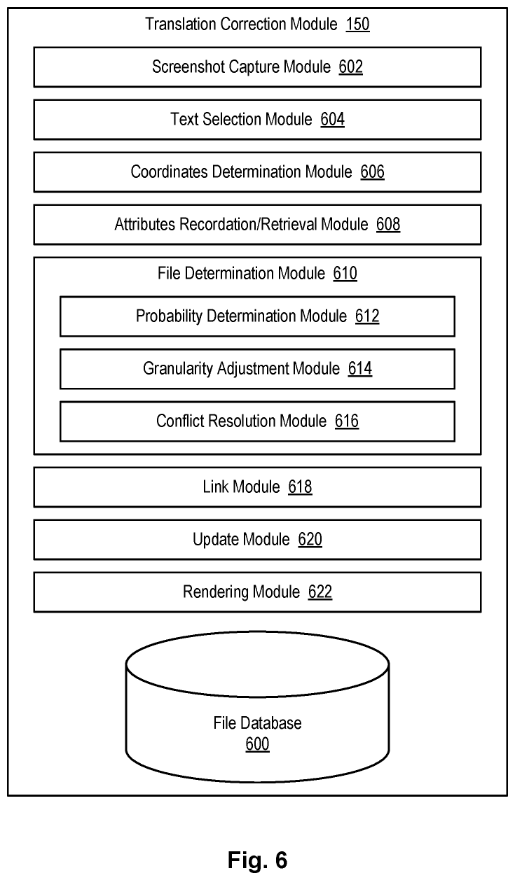

Referring to FIG. 6, in certain embodiments, a plurality of files (sometimes referred as Product User Interface files or PII files) stored in a file database 600 may store text for different languages that are presented on a graphical user interface 200. If a textual translation error is identified in the graphical user interface 200 or a screenshot 500 of the graphical user interface 200, the appropriate file and corresponding text in the file may need to be retrieved in order to correct the translation error. Once the text is modified, the file may be saved to correct the translation error.

In certain embodiments in accordance with the invention, selecting text 202 in a graphical user interface 200 and/or screenshot 500 of the graphical user interface 200 may be configured to automatically link to or retrieve a corresponding file in the file database 600 and to the corresponding text in the file so that a translation error may be corrected. In certain embodiments, this may be accomplished by searching for the selected text 202 in files of the database 600 and determining which instances of the text in the files are linked to or associated with the text 202 displayed on the graphical user interface 200 and/or screenshot 500 of the graphical user interface 200. Once these links or associations are determined, the links may be stored in a database such as a relational database such that when text 202 is selected in the graphical user interface 200 or screenshot 500 of the graphical user interface 200, the corresponding files in the file database 600 may be automatically retrieved from the file database 600 and the corresponding text may be automatically located within these files in order to enable correction of translation errors. Alternatively or additionally, links or associations between particular text and files containing the text may be stored in picture attributes of a screenshot 500 of the graphical user interface 200.

FIG. 6 is a high-level block diagram showing a translation correction module 150 and associated sub-modules. The translation correction module 150 and associated sub-modules may be implemented in hardware, software, firmware, or combinations thereof. The translation correction module 150 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, in certain embodiments, a translation correction module 150 in accordance with the invention may include one or more of a screenshot capture module 602, text selection module 604, coordinates determination module 606, attributes recordation/retrieval module 608, file determination module 610, link module 618, update module 620, and rendering module 622. The file determination module 610 may include one or more of a probability determination module 612, granularity adjustment module 614, and conflict resolution module 616.

The screenshot capture module 602 may enable a user to capture a screenshot 500 of a graphical user interface 200 so that text in the screenshot 500 can by analyzed for translation errors. The text selection module 604 may enable the user to select text 202 in the screenshot 500, such as text 202 requiring correction. When text 202 is selected, the coordinates determination module 606 may determine the coordinates 300a-d of the text 202 within the screenshot 500. The attributes recordation/retrieval module 608 may record the text 202 and its associated coordinates 300a-d in picture attributes of the screenshot 500 and, once saved, retrieve this information when the text 202 is selected on the screenshot 500.

The file determination module 610 may determine which file or files are associated with selected text 202 of a screenshot 500. For example, when text 202 is selected on the screenshot 500, the file determination module 610 may search through a file database 600 for a file that is linked to or associated with the selected text 202. In certain embodiments, the file determination module 610 may accomplish this using one or more of a probability determination module 612, granularity adjustment module 614, and conflict resolution module 616.

In some cases, text 202 that is selected on the screenshot 500 may be contained within multiple files of the file database 600. Although the same or similar to the selected text 202, some instances of the text in the files may not actually be linked to or associated with the text 202 on the screenshot 500. Modifying this text may not create the desired changes on the graphical user interface 200. Thus, the file determination module 610 may contain functionality to determine if text in the files is actually linked to or associated with the text 202 on the screenshot 500 such that changing the text will cause desired changes to the text 202 on the graphical user interface 200.

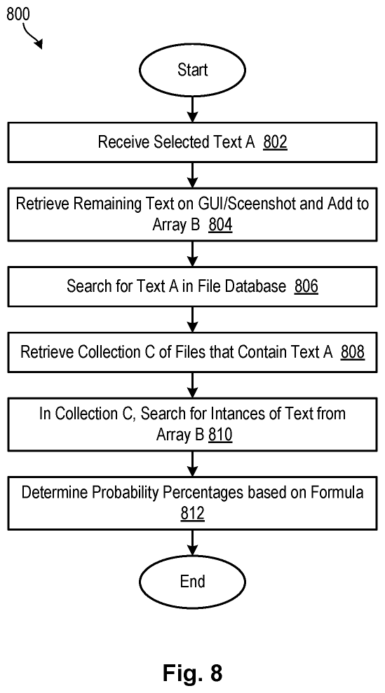

In order to determine which files in the file database 600 contain text that links to or is associated with selected text 202 on the screenshot 500, the probability determination module 612 may determine a probability percentage associated with each file in which the same or similar text is contained. This probability percentage may indicate the likelihood that text in the file links to the selected text 202 on the screenshot 500. One technique for calculating the probability percentage will be discussed in association with FIG. 8. In certain embodiments, the file with the highest calculated probability percentage will be considered the file with text that is linked to and/or associated with the selected text 202.

In the event the selected text 202 cannot be found in any of the files in the file database 600, the granularity adjustment module 614 may be used to adjust the granularity of the selected text 202. For example, the selected text 202 may be broken into shorter phrases, such as at commas, periods, or other natural breaking points. The file determination module 610 may then look for these shorter phrases in the files of the database 600. If found, the files may be assigned probability percentages as previously discussed and the file with the largest probability percentage may be deemed to be the file containing text that is linked to or associated with the selected text 202.

In the event multiple files are assigned the same probability percentage, the conflict resolution module 616 may assist in resolving the conflict, such as by using other means to determine which file contains the text that is linked to or associated with the selected text 202 on the screenshot 500. This may be accomplished in various different ways, such as by trial and error, analyzing other parts of the graphical user interface 200 and/or screenshot 500, or querying a user for additional information in order to determine which file contains the desired text.

Once text in a file is linked to or associated with selected text 202 on a screenshot 500 or graphical user interface 200, the link module 618 may document or record the link between the two. In certain embodiments this information may be stored in a database and/or picture attributes of the screenshot 500 so that if the text 202 is ever selected again, the corresponding file may be directly retrieved from the file database 600 without having to perform the searching described above.

When a file is retrieved for selected text 202, the update module 620 may enable a user (or other functionality such as artificial intelligence) to update corresponding text in the file in order to make desired changes to the graphical user interface 200. The rendering module 622 may re-render the graphical user interface 200 to enable the user to verify that any translation errors were properly corrected.

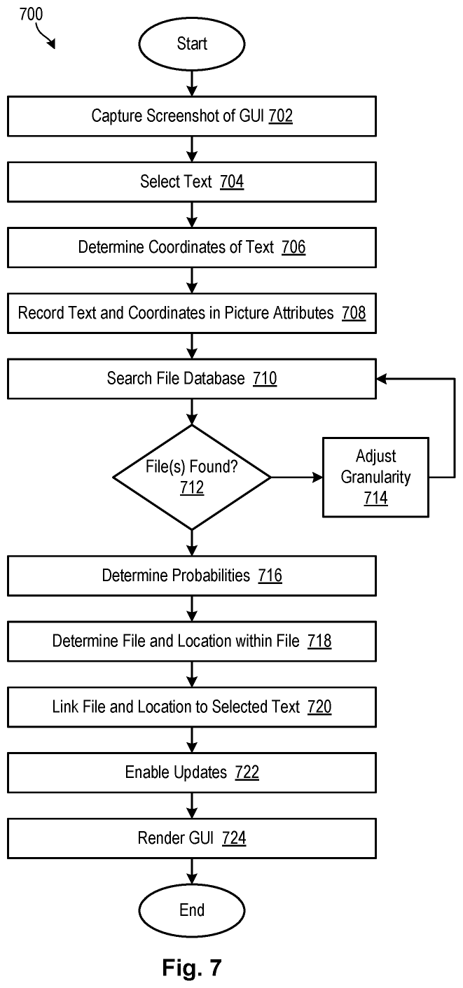

Referring to FIG. 7, one embodiment of a method 700 for correcting translation errors when performing GUI globalization testing is illustrated. In certain embodiments, such a method 700 may be executed by the translation correction module 150 previously described.

As shown, the method 700 initially captures 702 a screenshot 500 of a graphical user interface 200 in order to perform globalization testing. The method 700 enables text 202 to be selected 704 on the screenshot 500. The method 700 determines 706 coordinates 300a-d of the text 202 on the screenshot 500 and records 708 the text 202 and associated coordinates 300a-d in picture attributes of the screenshot 500.

The method 700 then searches 710 a file database 600 for files that contain text that is the same as or similar to the selected text 202. If files are found 712 in the file database 600, the method 700 may move on to next steps 716-724. If files are not found 712 in the file database 600, the method 700 adjusts 714 the granularity of the selected text 202, such as by breaking the selected text 202 into smaller phrases. The method 700 then searches 710 the file database 600 for the smaller phrases.

If the phrases are found in files of the file database 600, the method 700 determines 716 probability percentages for the files. These probability percentages may indicate the likelihood that the text in the files is linked to or associated with the selected text 202. Using these probability percentages, the method 700 determines 718 the file that contains or most likely contains the selected text 202. This may be accomplished by selecting the file with the highest probability percentage.

The method 700 may then link 720 the file and a particular location within the file to the selected text 202. This link may be stored in a database and/or picture attributes of the screenshot 500 from which the text 202 was selected. At this point, the method 700 may enable 722 a user (or other functionality such as artificial intelligence algorithms) to update the corresponding text in the file in order to correct any translation error in the graphical user interface 200. The method 700 may then render 724 the graphical user interface 200 to verify that the changes have been correctly implemented.

Referring to FIG. 8, a process flow diagram showing one embodiment of a method 800 for determining probability percentages for files containing selected text 202 is illustrated. As shown, the method 800 initially receives 802 selected text “A” from a graphical user interface 200 or screenshot 500 of the graphical user interface 200. The method 800 then retrieves 804 all or part of the remaining text on the graphical user interface 200 or screenshot 500 to add to an array “B”. In certain embodiments, the text that is added to the array “B” is text (e.g., terms, phrases, etc.) of the same granularity as the selected text “A”, although this is not necessary in all embodiments.

The method 800 then searches 806 files of the file database 600 for the selected text “A”. Assuming at least one file is found that contains the selected text “A”, the method 800 retrieves 808 a collection “C” of files that contain selected text “A”. In the files of collection “C”, the method 800 searches 810 for instances of the text from array “B”. The method 800 may then determine 812 a probability percentage for each file in collection “C” based on this data.

For example, in certain embodiments, the probability percentage for a file is calculated by dividing the number of text members (e.g., phrases, etc.) from array “B” that are found in the file, divided by the total number of text members in array “B”. The reasoning here is that if selected text “A” is found in the file, and if many of the text members from array “B” from the same graphical user interface 200 or screenshot 500 as selected text “A” are also found in the same file, then there is a higher probability that the text in the file will be linked to or associated with selected text “A.” It follows that a file will be assigned a lower probability percentage if it contains selected text “A” but does not contain any text members from array “B”, or contains a smaller number of the text members from array “B”.

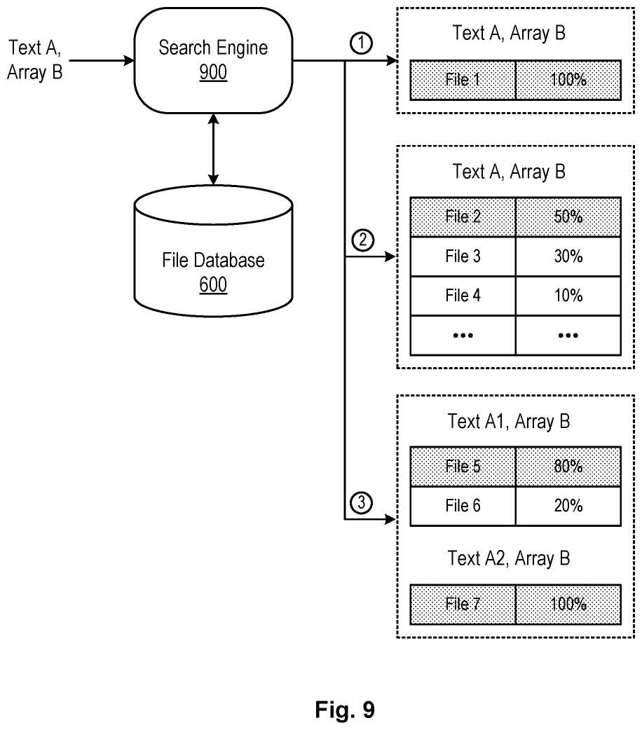

For example, FIG. 9 shows possible results when implementing the method 800 of FIG. 8. As shown, a search engine 900 may receive as inputs selected text “A” and array “B”. The search engine 900 may then search a file database 600 for files containing selected text “A”. For those files that contain selected text “A”, the search engine 900 may search for text members from array “B”. Using this information, probability percentages may be calculated for each of the files that contain selected text “A”.

In case 1 shown in FIG. 9, assume that only a single file (i.e., “file 1”) is discovered that contains selected text “A”. Further assume that the file also contains all text from array “B”. In such a case, the file may be assigned a probability percentage of one hundred percent. In this case, the text in the file will be used to correct translation errors in selected text “A” since the text in the file is linked to or associated with selected text “A”.

In case 2 shown in FIG. 9, assume that multiple files (i.e., files 2-4) are discovered in the file database 600 that contain selected text “A”. However, these files all contain different numbers of text members from array “B”. In such a case, each of the files may be assigned a different probability percentage to reflect the differing numbers of text members from array “B”. The file with the largest probability percentage (i.e., “file 2”) may be deemed to contain the text that is linked to or associated with selected text “A”. This text may be modified or updated to correct translation errors in selected text “A”.

In case 3, assume that selected text “A” cannot be found in any of the files of the file database 600. In such a case, selected text “A” may be broken into smaller phrases (i.e., text “A1” and text “A2”) and the search engine 900 may search for these smaller phrases in the file database 600. Assume that text “A1” is found in multiple files with each having different probability percentages since they contain different numbers of text members from array “B”. Assume that text “A2” is found in a single file that also contains all the text from array “B”. In this particular case, the file containing text “A1” with the largest probability percentage (i.e., “file 5”) may be deemed to contain the text that is linked to or associated with text “A1”. This text may be modified or updated to correct translation errors in selected text “A1”. Similarly, the file containing text “A2” with the largest probability percentage (i.e., “file 7”) may be deemed to contain the text that is linked to or associated with text “A2”.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for correcting translation errors when performing GUI globalization testing, the method comprising:
taking a screenshot of a graphical user interface (GUI);
enabling a user to select text in the screenshot;
in response to the selection, automatically retrieving a file in which at least some portion of the text is contained;
automatically locating, within the file, the portion; and
enabling the user to update the portion in the file in order to update corresponding text in the graphical user interface.

2. The method of claim 1, wherein enabling the user to select the text in the screenshot comprises retrieving, from picture attributes of the screenshot, coordinates in the screenshot associated with the text.

3. The method of claim 1, wherein enabling the user to select the text in the screenshot comprises retrieving the text from picture attributes of the screenshot.

4. The method of claim 1, further comprising calculating a probability percentage for the file, the probability percentage indicating a probability that the text in the file links to the selected text in the graphical user interface.

5. The method of claim 1, wherein enabling the user to select the text comprises enabling the user to select the text at a desired granularity.

6. The method of claim 5, further comprising calculating a probability percentage for the file, the probability percentage indicating a probability that the text in the file at the desired granularity links to the selected text in the graphical user interface.

7. The method of claim 1, wherein retrieving the file comprises retrieving the file from a plurality of files associated with the graphical user interface.

8. A computer program product for correcting translation errors when performing GUI globalization testing, the computer program product comprising a computer-readable storage medium having computer-usable program code embodied therein, the computer-usable program code configured to perform the following when executed by at least one processor:
take a screenshot of a graphical user interface (GUI);
enable a user to select text in the screenshot;
in response to the selection, automatically retrieve a file in which at least some portion of the text is contained;
automatically locate, within the file, the portion; and
enable the user to update the portion in the file in order to update corresponding text in the graphical user interface.

9. The computer program product of claim 8, wherein enabling the user to select the text in the screenshot comprises retrieving, from picture attributes of the screenshot, coordinates in the screenshot associated with the text.

10. The computer program product of claim 8, wherein enabling the user to select the text in the screenshot comprises retrieving the text from picture attributes of the screenshot.

11. The computer program product of claim 8, wherein the computer-usable program code is further configured to calculate a probability percentage for the file, the probability percentage indicating a probability that the text in the file links to the selected text in the graphical user interface.

12. The computer program product of claim 8, wherein enabling the user to select the text comprises enabling the user to select the text at a desired granularity.

13. The computer program product of claim 12, wherein the computer-usable program code is further configured to calculate a probability percentage for the file, the probability percentage indicating a probability that the text in the file at the desired granularity links to the selected text in the graphical user interface.

14. The computer program product of claim 8, wherein retrieving the file comprises retrieving the file from a plurality of files associated with the graphical user interface.

15. A system for correcting translation errors when performing GUI globalization testing, the system comprising:
at least one processor;
at least one memory device operably coupled to the at least one processor and storing instructions for execution on the at least one processor, the instructions causing the at least one processor to:
take a screenshot of a graphical user interface (GUI);
enable a user to select text in the screenshot;
in response to the selection, automatically retrieve a file in which at least some portion of the text is contained;
automatically locate, within the file, the portion; and
enable the user to update the portion in the file in order to update corresponding text in the graphical user interface.

16. The system of claim 15, wherein enabling the user to select the text in the screenshot comprises retrieving, from picture attributes of the screenshot, coordinates in the screenshot associated with the text.

17. The system of claim 15, wherein enabling the user to select the text in the screenshot comprises retrieving the text from picture attributes of the screenshot.

18. The system of claim 15, wherein the instructions further cause the at least one processor to calculate a probability percentage for the file, the probability percentage indicating a probability that the text in the file links to the selected text in the graphical user interface.

19. The system of claim 15, wherein enabling the user to select the text comprises enabling the user to select the text at a desired granularity.

20. The system of claim 19, wherein the instructions further cause the at least one processor to calculate a probability percentage for the file, the probability percentage indicating a probability that the text in the file at the desired granularity links to the selected text in the graphical user interface.
